(19) United States
(12) Patent Application Publication
(10) Pub. No.: US 2017/0008370 A1
(43) Pub. Date: Jan. 12, 2017

(54) Valve Device and Air Conditioning System

(71) Applicant: CATERPILLAR SARL, Geneva (CH)

(72) Inventor: Ken Hiraoka, Tokyo (JP)

(73) Assignee: Caterpillar SARL, Geneva (CH)

(21) Appl. No.: 15/116,431

(22) PCT Filed: Feb. 17, 2015
(86) PCT No.: PCT/EP2015/053312

§ 371 Date: Aug. 3, 2016

(30) Foreign Application Priority Data
Feb. 18, 2014 (JP) 2014-028818

(51) Int. Cl. B60H 1/00; F25B 41/06; F25B 41/00

(52) U.S. Cl. CPC B60H 1/00485; F25B 41/003; F25B 41/062; F25B 2341/06; F25B 2500/13

(57) ABSTRACT

A plurality of coolant piping lines are connected via valve, body flange members, which include respective recesses which are notched toward respective piping line insertion holes into which respective coolant piping lines are inserted, projections which are projected from respective recesses, and screw insertion holes which are arranged on a respective projection or recess, recesses and projections being combined with one other to make continuous screw insertion holes into which a fixing screw is inserted to fix the flange members.

### TECHNICAL FIELD

The present invention relates to a valve device with a pipe assembly structure in which a plurality of pipes is assembled to one pipe connection surface of a valve main body.

### BACKGROUND ART

As depicted in FIG. 7, an air conditioning system includes a compressor 1, condenser 2, a receiver 3, an expansion valve 4, and an evaporator 5 which are connected together in a loop circuit. The air conditioning system has a pipe assembly structure in which, in order to assemble a plurality of air conditioner refrigerant pipes 6a and 6b to one pipe connection surface 4a of the box-shaped expansion valve 4, flange members 7a and 7b are attached to refrigerant pipes 6a and 6b, respectively, and fastened to a block joint 9 via flange fixation screws 8a and 8b, respectively, and the block joint 9 is fastened to a valve main body 4b of the expansion valve 4 via a joint fixation screw 9a (see, for example, Patent Document 1).

When such a pipe assembly structure is applied to a construction machine with heavy vibration, the refrigerant pipes 6a and 6b need to be brazed to the flange members 7a and 7b in order to be more firmly fastened. A reason why the refrigerant pipes 6a and 6b are not brazed directly to the block joint 9 is to maintain assemblability. When the two refrigerant pipes 6a and 6b are first brazed to the one block joint 9, the assembly of the refrigerant pipes 6a and 6b is constrained in that hoses with different routes like the refrigerant pipes 6a and 6b are simultaneously assembled from the same place. This degrades assemblability. Thus, the block joint 9 is needed to collectively attach the flange members 7a and 7b brazed to the refrigerant pipes 6a and 6b, respectively, to the valve main body 4b of the expansion valve 4 in the final.

Another reason for the need of the block joint 9 is that the expansion valve 4, which is small in size, has no extra space in which threaded holes are formed through which a plurality of flange fixation screws 8a and 8b is screw threaded, so that only one threaded hole 1b is available through which the joint fixation screw 9a allowing fastening of the block joint 9 is screw threaded. Thus, the block joint 9 is indispensable. The absence of the block joint 9 precludes the two flange members 7a and 7b from being fastened to the one pipe connection surface 4a.

Furthermore, although not shown in the drawings, another pipe assembly structure is available. To allow a plurality of refrigerant pipes to be assembled to one pipe connection surface of a box-shaped expansion valve, a flange member and a rubber tube are attached to each refrigerant pipe, whereas a plurality of tapered bores is formed in a block joint. Then, the rubber tubes of the refrigerant pipes are compressed using the tapered bores, while the block joint is fastened to an expansion valve via a joint fixation screw. Thus, the flange members are fixedly pressed against the valve main body of the expansion valve to assemble the refrigerant pipes to the valve main body (see, for example, Patent Document 2).

The block joint is also indispensable for this pipe assembly structure using the rubber tubes. The absence of the block joint precludes the two flange members from being fastened to the one pipe connection surface of the expansion valve.

[Patent Document 1] Japanese Patent Application Laid-open No. 2005-324777

[Patent Document 2] Japanese Patent Application Laid-open No. 2010-116939

In the pipe assembly structures disclosed in Patent Document 1 and Patent Document 2, the use of the block joint is indispensable for assembling the plurality of refrigerant pipes to the one pipe connection surface of the expansion valve. However, the block joint is expensive. A structure that allows the block joint to be abolished has been desired.

The present invention has been developed in view of these points. It is an object of the present invention to provide a valve device that allows abolishment of a block joint, which is expensive, when a plurality of pipes is assembled to one pipe connection surface of a valve main body, and an air conditioning system using the valve device.

### DISCLOSURE OF THE INVENTION

An invention set forth in claim 1 is a valve device allowing a plurality of pipes to be assembled to one pipe connection surface of a valve main body via a plurality of flange members, the valve device including: a first flange member including a first pipe insertion hole into which a first pipe is inserted, a first recess portion formed like a cutout toward the first pipe insertion hole along a surface intersecting an axial direction of the first pipe insertion hole, a first protruding portion formed so as to protrude from the first recess portion in a direction away from the first pipe insertion hole along a surface intersecting the axial direction of the first pipe insertion hole, and a first screw insertion hole formed in the first protruding portion; a second flange member including a second pipe insertion hole into which a second pipe is inserted, a second recess portion formed like a cutout toward the second pipe insertion hole along a surface intersecting an axial direction of the second pipe insertion hole, a second protruding portion formed so as to protrude from the second recess portion in a direction away from the second pipe insertion hole along a surface intersecting the axial direction of the second pipe insertion hole, and a second screw insertion hole that is formed at a position in the second protruding portion and is contiguous with the first screw insertion hole in a fitted state where the first recess portion and the second protruding portion are fitted together and where the first protruding portion and the second recess portion are fitted together; and one fixation screw inserted through the first screw insertion hole and the second screw insertion hole in the fitted state to tighten the first flange member and the second flange member into threaded holes in the valve main body.

An invention set forth in claim 2 is the valve device set forth in claim 1, in which each of the flange members is brazed to each pipe.

An invention set forth in claim 3 is an air conditioning system including a compressor that compresses a refrigerant, a condenser that is connected to a discharge side of the compressor and releases heat from the refrigerant having a high temperature and a high pressure to an outside to condense the refrigerant, a receiver shaped like a closed container and connected to the condenser to receive condensed liquid refrigerant, an expansion valve connected to the receiver and containing a variable orifice that sprays and atomizes the liquid refrigerant and a temperature sensing section that automatically adjusts the variable orifice in accordance with a refrigerant temperature, and an evaporator that has a first end connected to the variable orifice of the expansion valve and a second end connected to a suction side of the compressor via the temperature sensing section of the expansion valve, and that absorbs heat from the outside to evaporate the refrigerant, in which the valve device set forth in claim 1 or 2 is a box-shaped expansion valve that allows two pipes to be assembled to one pipe connection surface of a valve main body via two flange members, one of the pipes is a refrigerant pipe connected to the receiver, and the other pipe is a refrigerant pipe connected to the compressor.

The invention set forth in claim 1 is configured as follows. The recess portion and the protruding portion are formed on each of the flange members of each of the pipes. The recess portions and the protruding portions are fitted together to make the screw insertion holes in the plurality of flange members contiguous with one another. The fixation screw is inserted through the screw insertion holes and screw threaded into the only one threaded hole in the valve main body. Consequently, the assembled plurality of flange members can be fastened to the valve main body using the one fixation screw. Thus, a block joint, which is expensive, can be abolished, and high assemblability can be ensured without assembly operation constraint by the block joint. Furthermore, the plurality of pipes can be easily attached to the small pipe connection surface of the valve main body, allowing elimination of the need for other additional components and assembly steps.

According to the invention set forth in claim 2, the pipes with the flange members simply brazed thereto can be freely handled in each of the assembly operations and finally fixed directly to the valve main body via the flange members. Thus, assemblability can be improved. Furthermore, the flange members integrated with the respective pipes by brazing are fixed directly to the valve main body. This allows elimination of the need for other members such as vibration isolation members.

According to the invention set forth in claim 3, when the box-shaped expansion valve, receiver, and compressor in the air conditioning system are connected together using one and the other of the refrigerant pipes, a block joint, which is conventionally needed and is expensive, can be abolished and high assemblability can be ensured without assembly operation constraint by the block joint. Furthermore, one and the other of the refrigerant pipes can be easily attached to the valve main body, allowing elimination of the need for other additional components and assembly steps.

### BRIEF DESCRIPTION OF THE DRAWINGS

FIG. 1 is a perspective view and a circuit diagram depicting an embodiment of a valve device and an air conditioning system according to the present invention;

FIG. 2 is a perspective view of a first flange member of the valve device;

FIG. 3 is a perspective view of a second flange member of the valve device;

FIG. 4 is a perspective view of a valve main body of the valve device;

FIG. 5 is a perspective view depicting another embodiment of the first flange member of the valve device;

FIG. 6 is a perspective view depicting another embodiment of a second flange member of the valve device; and

FIG. 7 is a side view depicting a conventional valve device.

### BEST MODE FOR CARRYING OUT THE INVENTION

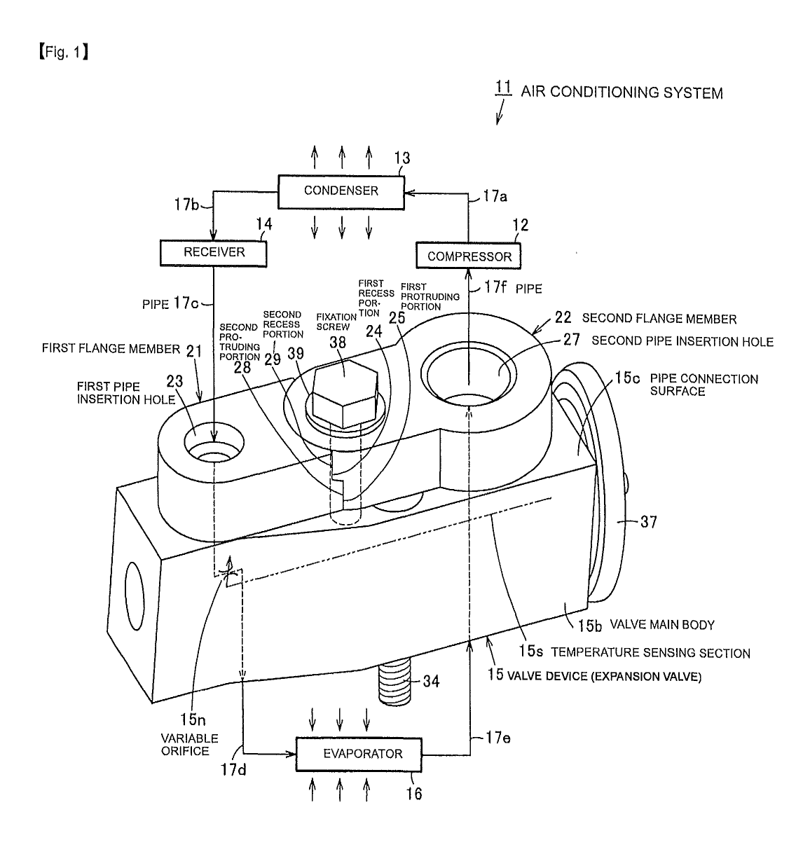

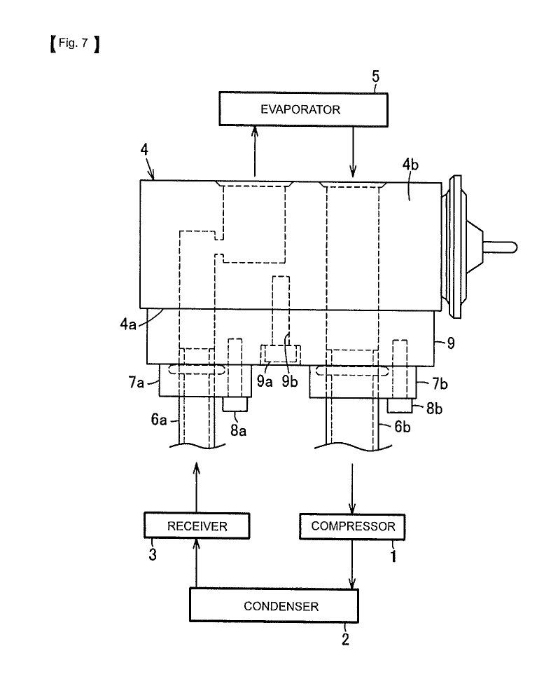

The present invention will be described below in detail based on an embodiment depicted in FIGS. 1 to 4 and an another embodiment depicted in FIG. 5 and FIG. 6.

FIG. 1 depicts an air conditioning system 11 mounted in a construction machine such as an excavator as a cab interior air conditioning device. The air conditioning system 11 includes a compressor 12 that compresses a refrigerant, a condenser 13 that is connected to a discharge side of the compressor 12 and releases heat from the refrigerant having a high temperature and a high pressure to the outside to condense the refrigerant, a receiver 14 shaped like a closed container and connected to the condenser 13 to receive condensed liquid refrigerant, an expansion valve 15 serving as a valve device, connected to the receiver 14 and containing a variable orifice (needle valve) 15n that sprays the liquid refrigerant into a valve main body 15b for atomization and a temperature sensing section 15s shaped like a rod and automatically adjusting the variable orifice 15n in accordance with a refrigerant temperature, and an evaporator 16 that has a first end connected to the variable orifice 15n of the expansion valve 15 and a second end connected to a suction side of the compressor 12 via the temperature sensing section 15s of the expansion valve 15, and that absorbs heat from the outside to evaporate the refrigerant. These components are connected together using refrigerant pipes 17a, 17b, 17c, 17d, 17e, and 17f as pipes.

FIG. 1 depicts a pipe assembly structure in which a plurality (two) of the refrigerant pipes 17c and 17f is assembled to one pipe connection surface 15c of a valve main body 15b of the expansion valve 15 via a plurality (two) of the flange members 21 and 22. The flange members 21 and 22 are brazed to the refrigerant pipes 17c and 17f, respectively. The refrigerant pipe 17c, one of the pipes, is connected to an outlet side of the receiver 14. The refrigerant pipe 17f, the other pipe, is connected to a suction side of the compressor 12.

As depicted in FIG. 2, the first flange member 21 includes a first pipe insertion hole 23 into which the first refrigerant pipe 17c is inserted, a first recess portion 24 formed like a cutout toward the first pipe insertion hole 23 along a surface intersecting an axial direction of the first pipe insertion hole 23, a first protruding portion 25 formed so as to protrude from the first recess portion 24 in a direction away from the first pipe insertion hole 23 along a surface intersecting the axial direction of the first pipe insertion hole 23, and a first screw insertion hole 26 formed in the first protruding portion 25.

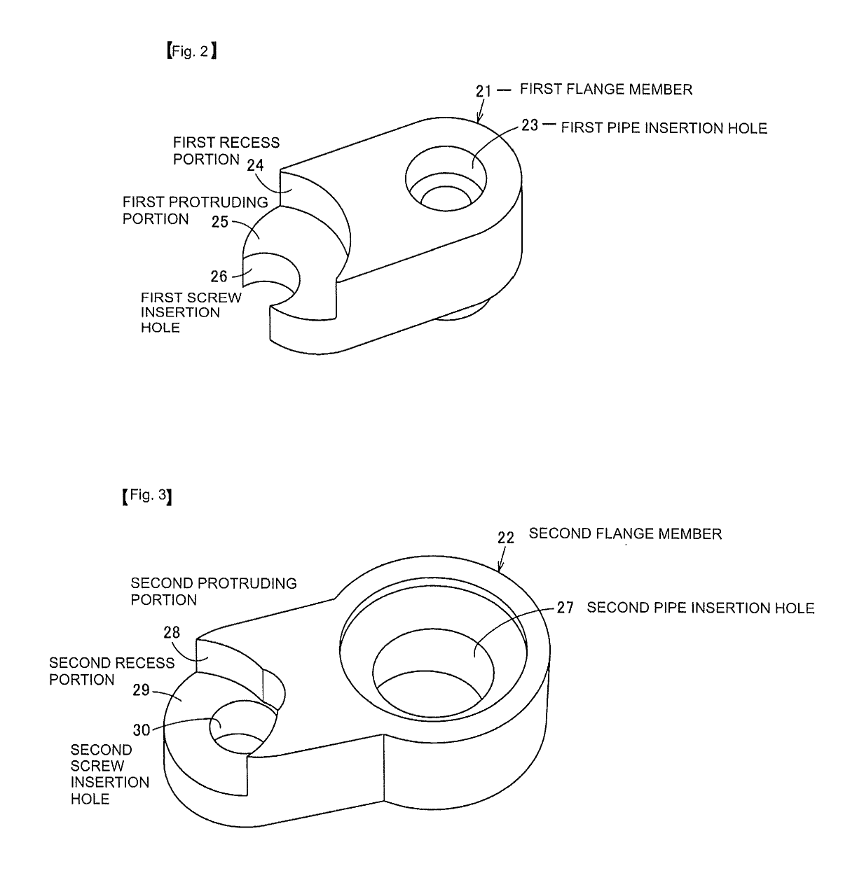

As depicted in FIG. 3, the second flange member 22 includes a second pipe insertion hole 27 into which the second refrigerant pipe 17f is inserted, a second recess portion 28 formed like a cutout toward the second pipe insertion hole 27 along a surface intersecting an axial direction of the second pipe insertion hole 27, a second protruding portion 29 formed so as to protrude from the second recess portion 28 in a direction away from the second pipe insertion hole 27 along a surface intersecting the axial direction of the second pipe insertion hole 27, and a second screw insertion hole 30 that is formed at a position in the second protruding portion 29 and is contiguous with the first screw insertion hole 26 in a fitted state where the first recess portion 24 and the second protruding portion 29 are fitted together and where the first protruding portion 25 and the second recess portion 28 are fitted together.

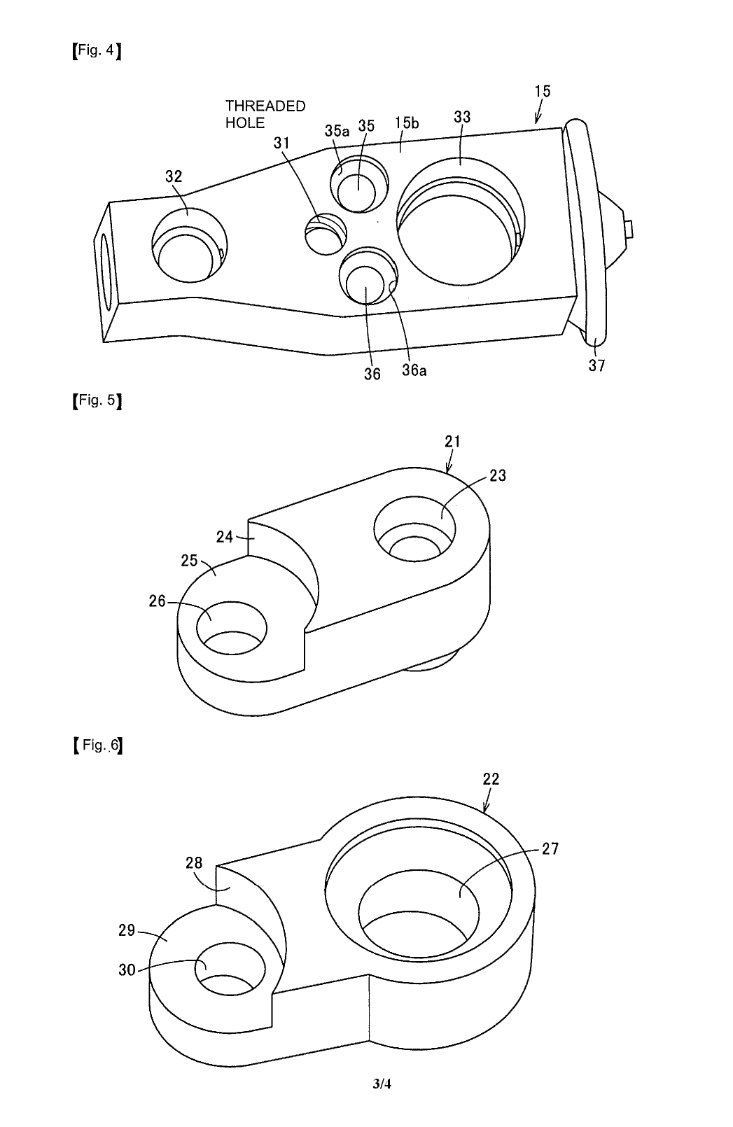

As depicted in FIG. 4, a threaded hole 31 is formed in the valve main body 15b at a central portion thereof. A first pipe screw threading hole 32 and a second pipe screw threading hole 33 are formed on one side and the other side, respectively of the threaded hole 31 in a longitudinal direction; the first pipe screw threading hole 32 is brazed to the first flange member 21 to allow the first refrigerant pipe 17c projecting from the flange member 21 to be screw threaded into the first pipe screw threading hole 32 via an O ring (not depicted in the drawings), and the second pipe screw threading hole 33 is brazed to the second flange member 22 to allow the second refrigerant pipe 17f projecting from the flange member 22 to be screw threaded into the second pipe screw threading hole 33 via an O-ring (not depicted in the drawings). Moreover, a pair of bolt insertion holes 35 and 36 is formed near the threaded hole 31 so that valve main body fixation bolts 34 (see FIG. 1) allowing the valve main body 15b to be fixed to a mounting member (not depicted in the drawings) on the side of an evaporator 16 can be inserted into the bolt insertion holes 35 and 36. The bolt insertion holes 35 and 36 include bolt head housing groves 35a and 36a allowing heads of the valve main body fixation bolts 34 to be inside the pipe connection surface 15c.

A rod-like temperature sensing section 15s (see FIG. 1) detecting the temperature of a refrigerant evaporated by the evaporator 16 is installed in the pipe screw threading hole 33 in the valve main body 15b so as to traverse and penetrate the valve main body 15b in a radial direction. The temperature sensing section 15s is connected to a diaphragm 37 provided on one side of the valve main body 15b.

As depicted in FIG. 1, after the valve main body 15b is fixed to the mounting member (not depicted in the drawings) on the side of an evaporator 16 via the valve main body fixation bolts 34, one fixation screw 38 is inserted through the first screw insertion hole 26 and the second screw insertion hole 30, screw threaded into the threaded hole 31 in the valve main body 15b, and tightened, in a fitted state where the recess portion 24 and first protruding portion 25 on the first flange member 21 with the first refrigerant pipe 17c brazed thereto are fitted with the second protruding portion 29 and second recess portion 28 on the second flange member 22 with the second refrigerant pipe 17f brazed thereto. Thus, the first flange member 21 and the second flange member 22 with the first refrigerant pipe 17c and the second refrigerant pipe 17f, respectively, brazed thereto are fixedly fastened to the valve main body 15b. Reference numeral 39 denotes a washer.

FIG. 5 and FIG. 6 depict an another embodiment of the first flange member 21 and the second flange member 22. The first flange member 21 and the second flange member 22 depicted in FIG. 2 and FIG. 3 are examples in which the screw insertion holes 26 and 30 are formed by processing existing flange members. The screw insertion holes 26 and 30 are partly shaped like cutouts. However, the screw insertion holes 26 and 30 with complete shapes may be formed by forming the protruding portion 25 of the first flange member 21 so that the protruding portion 25 projects further as depicted in FIG. 5, and forming the recess portion 28 of the second flange member 22 so that the recess portion 28 is more deeply cut as depicted in FIG. 6. The other portions are denoted by the same reference numerals and will not be described.

The effects and advantages of the above-described embodiments will be described below.

The recess portions 24 and 28 and the protruding portions 25 and 29 are formed on the flange members 21 and 22 of the refrigerant pipes 17c and 17f, respectively, and fitted together to make the screw insertion holes 26 and 30 in the plurality of flange members 21 and 22 contiguous with each other. Then, the fixation screw 38 is inserted through the screw insertion holes 26 and 30, and the combined plurality of flange members 21 and 22 can be fastened directly to the valve main body 15b via the one fixation screw 38 using the only one threaded hole 31 in the valve main body 15b. Thus, a conventional block joint, which is expensive, can be abolished, and high assemblability can be ensured without assembly operation constraint by the block joint. Furthermore, the plurality of refrigerant pipes 17c and 17f can be easily attached to the small pipe connection surface 15c of the valve main body 15b, allowing elimination of the need for other additional components and assembly steps.

The refrigerant pipes 17c and 17f with the flange members 21 and 22 simply brazed thereto can be freely handled in each of the assembly operations and finally fixed directly to the valve main body 15b via the flange members 21 and 22. Thus, assemblability can be improved. Furthermore, the flange members 21 and 22 integrated with the respective refrigerant pipes 17c and 17f by brazing are fixed directly to the valve main body 15b. This allows elimination of the need for other members such as vibration isolation members.

When the box-shaped expansion valve 15, receiver 14, and compressor 12 in the air conditioning system 11 are connected together using pipes, a block joint, which is conventionally needed and is expensive, can be abolished and high assemblability can be ensured without assembly operation constraint by the block joint. Furthermore, one and the other of the refrigerant pipes 17c and 17f can be easily attached to the valve main body 15b, allowing elimination of the need for other additional components and assembly steps.

The flange members 21 and 22 depicted in FIG. 2 and FIG. 3 and the flange members 21 and 22 depicted in FIG. 5 and FIG. 6 are only illustrative of recessed and protruding shapes and hole positions. Of course, the present invention is not limited to these forms.

### INDUSTRIAL APPLICABILITY

The present embodiment is industrially applicable for those skilled in manufacture or distribution of a valve device, an air conditioning system, and a construction machine with the valve device and the air conditioning system mounted therein.

### EXPLANATION OF REFERENCE NUMERALS

11 Air conditioning system

12 Compressor

13 Condenser

14 Receiver

15 Expansion valve as valve device

15b Valve main body

15c Pipe connection surface

15n Variable orifice

15s Temperature sensing section

16 Evaporator

17c Refrigerant pipe as pipe

17f Refrigerant pipe as pipe

21 First flange member

22 Second flange member

23 First pipe insertion hole

24 First recess portion

25 First projecting portion

26 First screw insertion hole

28 Second protruding portion

29 Second recess portion

30 Second screw insertion hole

31 Threaded hole

38 Fixation hole

1. A valve device allowing a plurality of pipes to be assembled to one pipe connection surface of a valve main body via a plurality of flange members, the valve device comprising:
a first flange member including:
a first pipe insertion hole into which a first pipe is inserted;
a first recess portion formed like a cutout toward the first pipe insertion hole along a surface intersecting an axial direction of the first pipe insertion hole;
a first protruding portion formed so as to protrude from the first recess portion in a direction away from the first pipe insertion hole along a surface intersecting the axial direction of the first pipe insertion hole; and
a first screw insertion hole formed in the first protruding portion;
a second flange member including:
a second pipe insertion hole into which a second pipe is inserted;
a second recess portion formed like a cutout toward the second pipe insertion hole along a surface intersecting an axial direction of the second pipe insertion hole;
a second protruding portion formed so as to protrude from the second recess portion in a direction away from the second pipe insertion hole along a surface intersecting the axial direction of the second pipe insertion hole; and
a second screw insertion hole that is formed at a position in the second protruding portion and is contiguous with the first screw insertion hole in a fitted state where the first recess portion and the second protruding portion are fitted together and where the first protruding portion and the second recess portion are fitted together; and
one fixation screw inserted through the first screw insertion hole and the second screw insertion hole in the fitted state to tighten the first flange member and the second flange member into threaded holes in the valve main body.

2. The valve device according to claim 1, wherein each of the flange members is brazed to each pipe.

3. An air conditioning system comprising:
a compressor that compresses a refrigerant;
a condenser that is connected to a discharge side of the compressor and releases heat from the refrigerant having a high temperature and a high pressure to an outside to condense the refrigerant;
a receiver shaped like a closed container and connected to the condenser to receive condensed liquid refrigerant;
an expansion valve connected to the receiver and containing a variable orifice that sprays and atomizes the liquid refrigerant and a temperature sensing section that automatically adjusts the variable orifice in accordance with a refrigerant temperature; and
an evaporator that has a first end connected to the variable orifice of the expansion valve and a second end connected to a suction side of the compressor via the temperature sensing section of the expansion valve, and that absorbs heat from the outside to evaporate the refrigerant,
wherein the valve device according to claim 1 is a box-shaped expansion valve that allows two pipes to be assembled to one pipe connection surface of a valve main body via two flange members,
one of the pipes is a refrigerant pipe connected to the receiver, and
the other pipe is a refrigerant pipe connected to the compressor.

4. An air conditioning system comprising:
a compressor that compresses a refrigerant;
a condenser that is connected to a discharge side of the compressor and releases heat from the refrigerant having a high temperature and a high pressure to an outside to condense the refrigerant;
a receiver shaped like a closed container and connected to the condenser to receive condensed liquid refrigerant;
an expansion valve connected to the receiver and containing a variable orifice that sprays and atomizes the liquid refrigerant and a temperature sensing section that automatically adjusts the variable orifice in accordance with a refrigerant temperature; and
an evaporator that has a first end connected to the variable orifice of the expansion valve and a second end connected to a suction side of the compressor via the temperature sensing section of the expansion valve, and that absorbs heat from the outside to evaporate the refrigerant,
wherein the valve device according to claim 1 is a box-shaped expansion valve that allows two pipes to be assembled to one pipe connection surface of a valve main body via two flange members,
one of the pipes is a refrigerant pipe connected to the receiver, and
the other pipe is a refrigerant pipe connected to the compressor.
